(19) United States
(12) Patent Application Publication
(10) Pub. No.: US 2009/0269544 A1
(43) Pub. Date: Oct. 29, 2009

(54) GLITTER ENHANCED FLOCK FABRIC

(75) Inventor: David Morrison, West Warwick, RI (US)

Correspondence Address: WOLF GREENFIELD & SACKS, P.C., 600 ATLANTIC AVENUE, BOSTON, MA, 02210-2206, US

(73) Assignee: Microfibres, Inc., Pawtucket, RI (US)

(21) Appl. No.: 12/111,071

(22) Filed: Apr. 28, 2008

(51) Int. Cl. B32B 3/02; B05D 1/16; B29C 65/48

(52) U.S. Cl. 428/86; 428/89; 156/62.2

(57) ABSTRACT

The present invention provides systems and methods for the incorporation of glitter particulates in flocked pile fabrics, as well as fabrics manufactured using the same. The fabrics produced according to the invention comprise flocking and glitter particulates at the exposed surface of the adhesive used to attach the flocking and glitter particulates to the fabric. By adhering the glitter particulates to the exposed surface of the adhesive layer—rather than admixing the glitter particulates with the adhesive—the decorative effect is maintained while reducing the amount of glitter particulates used in the manufacturing process. In addition, the process does not require the passage of glitter particulates through an adhesive deposition tool, thereby eliminating shape and size restrictions imposed by the use of such tools.

### FIELD OF INVENTION

The present invention relates generally to the incorporation of glitter on fabric and more particularly, to depositing glitter and flocking on fabrics and systems and methods associated with the same.

### BACKGROUND

The incorporation of decorative media, such as glitter particulates, in flocked fabrics is known in the art. One method of incorporating glitter in flocked fabrics involves admixing the glitter with the adhesive used to attach the flocking. This process results in the suspension of glitter being dispersed within the thickness of the deposited adhesive layer. Processes that incorporate admixed adhesives and glitter require appropriately sized glitter particulates compatible with the adhesive deposition tool, thus limiting the size and shape of glitter particulates that may be used. In addition, glitter that are suspended in the adhesive layer are not directly exposed to light. Therefore, the contribution of the suspended particulates to the desired decorative effect is diminished.

There remains a need in the art to provide an improved process for attaching flocking and glitter to a fabric surface. The present invention provides systems and methods for producing flocked pile fabrics that incorporate glitter at the exposed surface of the fabrics, and articles manufactured using the same.

### SUMMARY OF THE INVENTION

Systems and methods for depositing glitter and flock on fabrics are provided, as well as articles manufactured using the same.

One aspect of certain embodiments of the present invention involves a flocked fabric having glitter particulates incorporated onto the fabric using a method by which the glitter particulates visibility is not diminished in the fabrication process but in which the particulates are firmly secured to the fabric.

Another aspect of certain embodiments of the present invention involves a simple method of fabricating a novel glitter particulate enhanced flocked fabric utilizing conventional flocking equipment in a novel fashion.

Yet another aspect of certain embodiments of the present invention involves a method of fabricating a glitter particulate enhanced flocked fabric that is efficient, competitive, and results in a quality product.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of a process used to manufacture flocked fabrics according to one embodiment of the invention.

FIG. 2 is a schematic illustration of a process used to manufacture flocked fabrics according to another embodiment of the invention.

FIG. 3 is a schematic cross-sectional illustration of a flocked fabric according to one embodiment of the invention.

FIG. 4 is a schematic cross-sectional illustration of a flocked fabric according to another embodiment of the invention.

### DETAILED DESCRIPTION

The present invention provides systems and methods for the incorporation of glitter particulates in flocked pile fabrics, as well as fabrics manufactured using the same. The fabrics produced according to the invention comprise flocking and glitter particulates at the exposed surface of the adhesive used to attach the flocking and glitter particulates to the fabric. By adhering the glitter particulates to the exposed surface of the adhesive layer—rather than admixing the glitter particulates with the adhesive—the decorative effect is maintained or improved while reducing the amount of glitter particulates used in the manufacturing process. In addition, the process according to some embodiments does not require the passage of glitter particulates through an adhesive deposition tool, thereby eliminating shape and size restrictions imposed by the use of such tools.

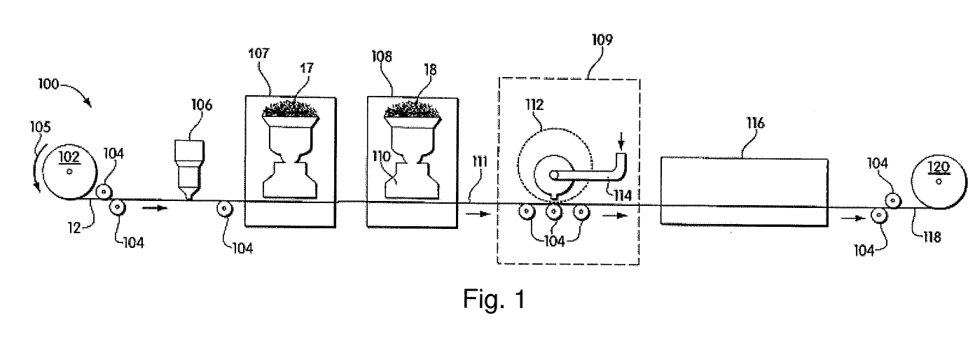

In one aspect, the invention relates to a method of depositing glitter particulates and flocking on a fabric substrate. Flocked fabric production system 100 shown in FIG. 1, illustrates a method of producing flocked fabric according to one embodiment of the invention. In this embodiment, roll 102 of a fabric substrate 12 can be conveyed, in the direction indicated by arrow 105, under tension from fabric substrate roll 102 to take up roll 120 via conventional motor drive mechanisms for controllably driving one roll (i.e. take up roll 120) or both rolls. The fabric substrate can be guided and supported along the path of the process via a series of support rollers 104. In other embodiments, instead of, or in addition to, conveying the fabric via motor-driven rotation of the take up roll/substrate roll, the fabric may be moved through the system via a conventional conveying system, such as a belt or apron conveyor.

“Fabric substrate” as used herein describes any material formed from a variety of woven, non-woven, or knitted fabric materials incorporating natural and/or synthetic fibers, or combinations thereof. In one particular embodiment, the fabric substrate can comprise a poly-cotton blend of 65%/35% having a weight in the order of 3.0 to 3.5 oz/sq. yd. The difference between the fabric substrate materials described above and non-fabric substrates (e.g. porous or non-porous plastic and paper sheets, and the like) will be apparent to those of ordinary skill in the art.

In one embodiment, an adhesive layer is applied to fabric substrate 12 by a conventional adhesive applicator 106, for example a roll coater, curtain coater, doctor blade, printing method etc. Typically, the adhesive is applied to the substrate by a doctor blade, although other methods such as printing, paint spraying and silk-screening may be used. In some embodiments, an adhesive layer is applied to the entire upper surface of fabric substrate 12. In other embodiments, the adhesive layer is applied such that one or more regions of fabric substrate 12 remain uncoated. “Adhesives” and “adhesive layers” as described herein may comprise any conventional adhesive known in the art for use in fabricating flocked pile fabrics that may also be used to permanently attach glitter particulates. Such adhesives include a wide variety of water based and/or solvent based adhesives. Also, as apparent to those of ordinary skill in the art, the adhesives may further include such components as viscosity modifiers, plasticizers, thermosetting resins, curing catalysts, stabilizers, and other additives well known in the art. The viscosity and composition of the adhesive chosen can be selected according to criteria readily apparent to those of ordinary skill in the art, including, but not limited to, the porosity and composition of substrate 12, the desired cure time and technique employed, the particular method of depositing pile fibers 18 onto the adhesive, the final weight and hand of the pile fabric desired, etc. In one particular embodiment, the adhesive layer comprises an acrylic polymer adhesive, which is applied on fabric substrate 12 to have an essentially uniform thickness and a coating density of about 2.0 to 3.0 oz/sq. yd. of pile fabric. For a more detailed discussion of adhesives and various additives which can be used for forming the adhesive layer, the reader is referred to U.S. Pat. No. 3,916,823 to Halloran, incorporated herein by reference.

Fabric substrate 12, now coated with a wet adhesive layer, is then passed to glitter chamber 107. In glitter chamber 107, glitter particulates 17 are deposited onto the wet adhesive layer to create an intermediate laminate. Glitter particulates may be deposited using a variety of methods such as, for example, spraying, sprinkling, or electrostatic deposition, among others. In some embodiments, the glitter particulates remain at the top surface of the adhesive layer. In some embodiments, the glitter particulates are deposited in random locations. In some embodiments, glitter particulates may cover at least 2%, at least 5%, or at least 10% of the exposed surface of the wet adhesive layer.

As used herein, the terms “glitter” or “glitter particulates” will be understood to include a collection of two or more pieces of material that, when applied to a surface of a substrate, provides the substrate with textures and/or appearances and/or surface modifications such that the substrate is provided with a sparkling, brilliant ornamental finish. Glitter particulates may comprise plastic, metal, glass, stone, paper, or other materials and/or combinations thereof. Glitter particulates may comprise, for example, materials designed to produce a metallic, iridescent, or holographic finish, or combinations thereof. The glitter particulates used in the embodiments disclosed herein may be of a wide range of types and sizes. In some embodiments, for example, the glitter particulates may have a mean characteristic dimension on the order of between about 0.03125 and about 0.1875 inches. As used herein, the “characteristic dimension” of a glitter particle refers to the largest distance separating any two points on the external surface of the particle as measured along a straight line passing through the geometric center of the particle. The terms “mean,” “average” or “mean average” as used herein shall mean the arithmetic mean average (i.e. number average) for a population of particles as measured by either microscopy or light scatter techniques, unless otherwise specified. The glitter particulates may comprise any shape such as, for example, squares, rectangles, circles, ellipses, half-moons, stars, among others. In addition, the glitter particulates may be either uniform or non-uniform in size and/or shape.

Fabric substrate 12, now coated with a wet adhesive layer and a layer of glitter particulates, is then passed to flocking chamber 108, which includes a pile applicator 110. In flocking chamber 108, as is conventional for producing flocked fabric, a layer of flocking formed by a multiplicity of pile fibers 18 is applied to the adhesive while it is still wet. Conventionally, and as hereinafter described, this deposition may be achieved by conventional beater bar or electrostatic techniques in which the ends of the pile fibers 18 adhere substantially to the wet adhesive layer. In some embodiments, the flocking adheres substantially to the wet adhesive layer but not to the glitter particulates. Pile fibers 18, in some embodiments, are oriented essentially perpendicular to the adhesive layer. In some embodiments, flocking chamber 108 may comprise an alternating current electrostatic flocking device having a variable frequency alternating electrostatic field that optimizes flocked fiber characteristics and processing efficiency, such as that described in co-owned U.S. Pat. No. 5,108,777 to Laird and incorporated herein by reference. In some embodiments, the pile fibers are uniformly oriented to form a uniform pile, which may be, in some cases, accomplished using electrostatic deposition techniques.

“Pile fibers,” “flock,” and “flocking” as described herein will be understood to include a wide variety of natural and/or synthetic fibers according to the particular desired characteristics of the resulting pile fabric once deposited. In one set of embodiments, pile fibers 18 are formed from a synthetic polymer material. In some embodiments, pile fibers 18 comprise nylon fibers. Fibers 18 for flocking may be natural in color or dyed, depending on the particular application, and a pile layer may be formed of pile fibers 18 which are all of the same color, thus forming a pile face having a solid color, or from a plurality of pile fibers 18 having different colors, thus forming a pile face that is multicolored. For use in the present invention, where a printed pattern is transferred to the pile fabric, it may be preferred, in some cases, to use pile fibers of the same color or undyed pile fibers.

The length of pile fibers 18, their denier, and the number density of the pile fibers on the adhesive layer can be varied over a relatively wide range and selected to yield a pile fabric having desirable characteristics for a particular application, as would be apparent to those of ordinary skill in the art. In some embodiments, pile fibers 18 can have a mean length on the order of between about 0.020 inches and about 0.065 inches. In some embodiments, pile fibers 18 can have a mean denier between about 0.45 and about 3.5. In some instances, pile fibers 18 can have an overall pile density of between about 1.0 to about 3.5 oz/sq. yd. of fabric. Pile fibers 18 can be deposited on the adhesive coated substrate, by a variety of methods conventional in the art, including the use of flocked depositing equipment of the beater bar type, or electrostatic flocking equipment, such as described in more detailed in commonly-owned U.S. Pat. No. 5,108,777 to Laird incorporated herein by reference. A printed pattern may also be transferred to the flocked fabric by a variety of conventional techniques, including, but not limited to, screen printing, transfer paper printing, painting, air brush, etc., as apparent to those of ordinary skill in the art.

After depositing glitter particulates and flocking, fabric substrate 12 is passed through a curing chamber 116 in order to cure the adhesive layer so that the glitter and flocking become permanently set. Curing chamber 116 may be comprised of any conventional curing equipment that exposes the uncured pile fabric to radiation to effect curing of the adhesive layer. Typical curing chambers operate by exposing the flocked fabric to a source of radiation, such as infrared radiation or heat, or ultraviolet radiation. In some embodiments, curing chamber 116 comprises a gas-fired air dryer, as is well known in the art, that exposes the flocked fabric to a flow of heated air to enable convective drying and curing of the adhesive. After being cured, the final laminate 118 exits the curing chamber and is wound onto take-up roll 120. The speed at which the fabric is conveyed through air embossing system 100 can vary depending on a number of operating factors, as apparent to those of ordinary skill in the art. For some typical embodiments, the speed would be in the range of about, for example, 25 to 150 ft/min.

In some embodiments, the flocked substrate may, optionally, be passed under air embossing cylinder 112 after application of the pile fibers. Referring to FIG. 1, the optional embossing apparatus is circumscribed by dotted line 109. Air embossing cylinder 112 may include an air lance therein that is in fluid communication with pressurized air supply line 114. In some embodiments, the flocked substrate is not embossed. Air embossing cylinder 112 typically comprises a cylindrical screen or stencil having perforations and solid areas therein. Pressurized air from air supply line 114 is directed by the air lance through the apertures or perforations in the cylindrical screen or stencil of embossing cylinder 112, in order to form the embossed features within the pile layer of the fabric. An embossed pattern is formed by deflection of pile fibers 18 in the pile layer by air flowing through the apertures within the cylindrical screen or stencil of embossing cylinder 112. Upon flowing through the apertures in the stencil of embossing cylinder 112 the air impinges upon pile fibers 18 and orients them in a direction that is dictated in part by the air velocity, direction of air flow, and size of the aperture in the stencil through which the air passes. In other words, those portions of the pile layer passing underneath apertures within the cylindrical stencil will become oriented to form the depressions in the embossed pattern, whereas those portions passing under solid areas of the stencil will not be subject to substantial air flow or reorientation of pile fibers 18 in the pile layer. As will be apparent to those of ordinary skill in the art, it is preferred that the adhesive layer be in a wet, uncured state during the air embossing procedure, such that the pile fibers 18 are not rigidly held by the adhesive and are able to have their position and orientation changed by an impinging air flow. The velocity of the air flow impinging upon the pile layer should be sufficient to exert a force on pile fibers 18 in order to create a desired degree of reorientation of the fibers. Systems and methods for air embossing fabrics are described in commonly-owned U.S. Pat. No. 6,770,240 to Laird entitled “Systems and Methods for Air Embossing Fabrics Utilizing Improved Air Lances,” which is incorporated herein by reference in its entirety and commonly-owned U.S. Pat. No. 6,935,229 to Laird, et al. entitled “Systems and Methods for Stabilizing the Rotation of Embossing Stencils Used for Air Embossing Fabrics,” which is incorporated herein by reference in its entirety.

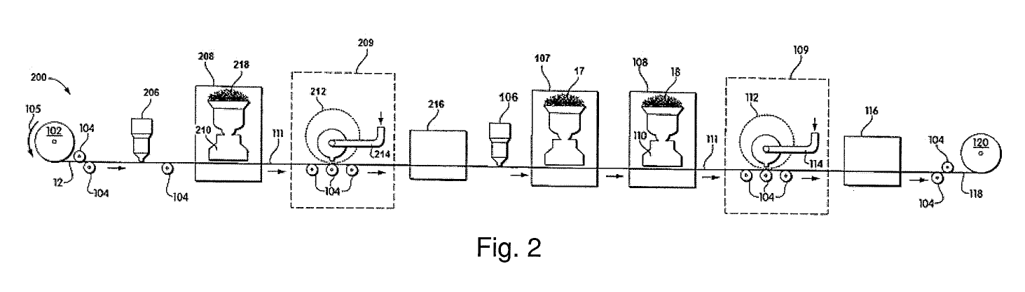

Another set of embodiments is directed to an alternative method of depositing glitter particulates and flocking on a fabric substrate. Flocked fabric production system 200 shown in FIG. 2, illustrates a method of producing flocked fabric according to this set of embodiments. Fabric substrate 12 may be conveyed in the direction of arrow 105. A first wet adhesive layer is applied to fabric substrate 12 by a conventional adhesive applicator 206. In some embodiments, an adhesive layer is applied to the entire upper surface of fabric substrate 12. In other embodiments, the adhesive layer is applied such that one or more regions of fabric substrate 12 remain uncoated. In some embodiments, glitter particulates may be applied to the first adhesive layer by a glitter chamber (not shown) while the first adhesive layer is still wet. Fabric substrate 12, now coated with a wet adhesive layer, is then passed to flocking chamber 208. In flocking chamber 208, a layer of flocking formed by a multiplicity of fibers 218 is applied to the first adhesive layer while it is still wet. In some embodiments, the pile fibers are uniformly oriented to form a uniform pile, which may be, in some cases, accomplished using electrostatic deposition techniques. In some embodiments in which glitter particulates are applied to the first adhesive layer, the flocking fibers 218 adhere substantially to the first wet adhesive layer but not to the glitter particulates. After applying the flocking to the adhesive layer, the fabric substrate is passed through curing chamber 216. In curing chamber 216, the adhesive layer is cured such that the flocking becomes permanently set to form flocked laminate. In some embodiments, the fabric substrate may, optionally, be passed under air embossing cylinder 212 after application of the flocking and before curing, resulting in an embossed flocked laminate.

After curing the first layer of flocking, a second wet adhesive layer is applied to flocked laminate by a conventional adhesive applicator 106. In some cases, the second wet adhesive layer is applied in a preselected pattern (e.g., floral, abstract, and/or geometric patterns, among others) onto the flocked laminate. After the application of the second wet adhesive layer, glitter particulates 17 may be applied to the second adhesive layer by glitter chamber 107 while the second adhesive layer is still wet. In some instances, the glitter is applied to the second wet adhesive layer at random locations. The glitter particulates may be intended to be adhered to the flocked laminate only in portions of the laminate having an exposed surface of the second wet adhesive layer.

After depositing glitter particulates to the second wet adhesive layer, a second layer of flocking may be deposited onto the flocked laminate by flocking chamber 108. In some embodiments, the second layer of flocking is deposited onto the remaining portions of the second wet adhesive layer not covered with glitter particulate. In some embodiments, the length (e.g, mean length), color(s), and/or denier of the fibers forming the first layer or flocking are different from the length (e.g, mean length), color(s), and/or denier of the fibers forming the second layer of flocking. In some embodiments, the second layer of flocking is deposited onto the flocked laminate while the second adhesive layer is still wet. As mentioned previously, the pile fibers, in some embodiments, may be uniformly oriented (using e.g. electrostatic deposition techniques) to form a uniform pile. After depositing the second layer of flocking, the flocked laminate is passed through a curing chamber 1 16 in order to cure the adhesive layer so that the glitter and flocking become permanently set to form a doubly-flocked laminate. In some embodiments, the flocked laminate (whether the first layer of flocking on the flocked laminate is embossed or not embossed) may, optionally, be passed under air embossing cylinder 112 after application of the second layer of flocking and before curing, resulting in an embossed doubly-flocked laminate. In some embodiments in which both layers of flocking have been embossed, the embossing applied to the first layer of flocking has a different pattern than the embossing applied to the second layer of flocking. In addition, in some embodiments in which both layers of flocking have been embossed, the length (e.g., mean length), color(s), and/or denier of the fibers used to form the first layer or flocking are different from the length (e.g., mean length), color(s), and/or denier of the fibers used to form the second layer of flocking.

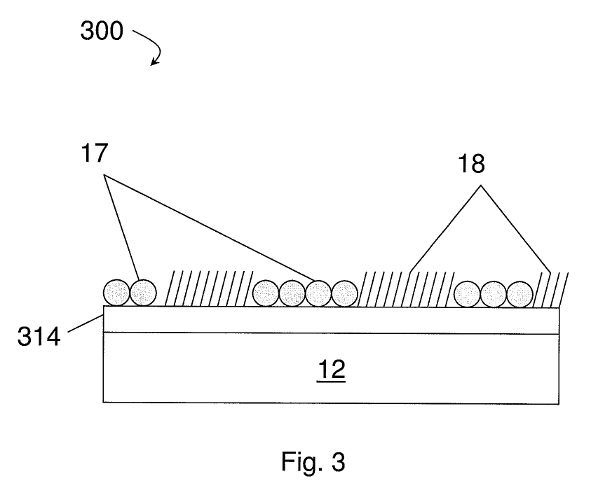

Another aspect of the invention relates to flocked fabrics. FIG. 3 is a schematic illustration of fabric article 300 according to one embodiment, which may be made using the process described in connection with FIG. 1. Fabric article 300 comprises fabric substrate 12. The fabric substrate can be formed from a variety of woven, non-woven, or knitted fabric materials incorporating natural and/or synthetic fibers, or combinations thereof. As illustrated in FIG. 3, fabric substrate 12 is coated with a first adhesive layer 314. The adhesive layer may comprise any conventional adhesive known in the art for use in fabricating flocked pile fabrics. In the embodiment illustrated in FIG. 3, the adhesive layer is applied to the entire upper surface of fabric substrate 12. In other embodiments, one or more regions of fabric substrate 12 is not coated with adhesive. FIG. 3 also illustrates regions of the adhesive layer 314 to which glitter particulates 17 are adhered. In addition, fabric article 300 includes regions of adhesive layer 314 to which flocking 18 is adhered. As illustrated in FIG. 3, the regions in which glitter particulates 17 are adhered to adhesive layer 314 are devoid of flocking 18, and the regions in which flocking 18 is adhered to adhesive layer 314 are devoid of glitter particulates 17. In some embodiments, flocking 18 may be embossed.

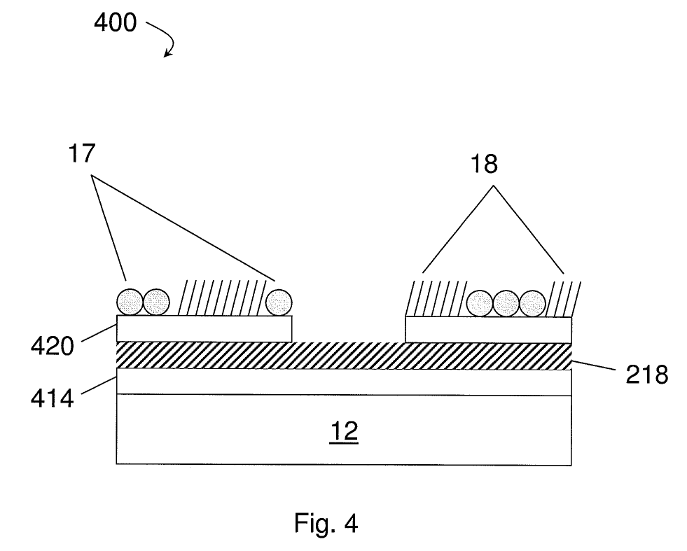

Yet another embodiment is illustrated in FIG. 4, which includes a schematic illustration of fabric article 400, which may be made using the process described in connection with FIG. 2. Fabric article 400 comprises fabric substrate 12. Fabric substrate 12 is coated with a first adhesive layer 414. In the embodiment illustrated in FIG. 4, the first adhesive layer 414 is applied to the entire upper surface of fabric substrate 12. In other embodiments, one or more regions of fabric substrate 12 are not coated with first adhesive layer 414. In FIG. 4, flocking 218 is adhered to first adhesive layer 414. In some embodiments, flocking 218 may be embossed. In some embodiments, glitter particulates may be adhered to the first adhesive layer (not shown in FIG. 4). In some cases in which glitter is adhered to the first adhesive layer, the regions in which glitter particulates are adhered to the first adhesive layer 414 are devoid of flocking 218, and the regions in which flocking 218 is adhered to adhesive layer 414 are devoid of glitter particulates.

Fabric article 400 includes a second adhesive layer 420, deposited over flocking 218. In some cases, second adhesive layer 420 is deposited in a preselected pattern (e.g., floral, abstract, and/or geometric patterns, among others). In cases where fabric substrate 12 includes uncovered regions after the deposition of first adhesive layer 414 (not shown in FIG. 4), second adhesive layer may also be in direct contact with portions of fabric substrate 12. Glitter particulates 17 are adhered to regions of second adhesive layer 420. In addition, additional flocking 18 is adhered to regions of second adhesive layer 420. In some embodiments, the regions in which glitter particulates 17 are adhered to second adhesive layer 420 are devoid of flocking 18, and the regions in which flocking 18 is adhered to second adhesive layer 420 are devoid of glitter particulates 17. In some embodiments, the length (e.g, mean length), color(s), and/or denier of the fibers forming the first layer or flocking are different from the length (e.g, mean length), color(s), and/or denier of the fibers forming the second layer of flocking. In some embodiments, flocking 18 may be embossed. In some embodiments in which both layers of flocking (218 and 18) are embossed, the embossing on the first layer of flocking comprises a different pattern than the embossing on the second layer of flocking. In addition, in some embodiments in which both layers of flocking (218 and 18) are embossed, the length (e.g., mean length), color(s), and/or denier of the fibers forming the first layer or flocking are different from the length (e.g., mean length), color(s), and/or denier of the fibers forming the second layer of flocking.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of depositing glitter particulates and flocking on a fabric substrate comprising the steps of:
applying a wet adhesive layer onto a fabric substrate;
thereafter depositing glitter particulates onto the wet adhesive layer to define an intermediate laminate;
thereafter depositing flocking onto the intermediate laminate while the adhesive layer is still wet; and
thereafter curing the adhesive layer to permanently secure the flocking to the adhesive layer to form a final laminate.

2. The method of claim 1, wherein the flocking is adhered to the adhesive layer, but not to the glitter particulate.

3. The method of claim 1, further comprising the step of embossing the flocking.

4. The method of claim 1, further comprising applying the wet adhesive layer to the fabric substrate in a preselected pattern.

5. The method of claim 1, wherein the glitter particulates have a mean characteristic dimension on the order of between about 0.03125 and about 0.1875 inches.

6. The method of claim 1, wherein the mean length of the flocking is on the order of between about 0.020 and about 0.065 inches.

7. A method of depositing glitter particulates and flocking on a fabric substrate comprising the steps of:
applying a first wet adhesive layer onto a fabric substrate;
thereafter depositing a first layer of flocking onto the first wet adhesive layer and curing the first wet adhesive layer to fix the flocking and form a flocked laminate;
thereafter applying a second wet adhesive layer onto the flocked laminate;
thereafter depositing glitter particulates onto the flocked laminate for adherence to the flocked laminate;
thereafter depositing a second layer of flocking onto the second wet adhesive layer; and
thereafter curing the second adhesive layer to permanently secure the flocking to the second adhesive layer to form a doubly-flocked laminate.

8. The method of claim 7, wherein the second wet adhesive layer is applied in a preselected pattern.

9. The method of claim 7, wherein the glitter particulates are deposited onto the flocked laminate for adherence to the flocked laminate only in portions of the laminate having an exposed surface of the second wet adhesive layer.

10. The method of claim 7, wherein the second layer of flocking is deposited onto the remaining portions of the second wet adhesive layer that are not covered by glitter particulates.

11. The method of claim 7, further comprising the step of embossing the first layer of flocking prior to applying the second layer of flocking.

12. The method of claim 7, further comprising the step of embossing the second layer of flocking prior to curing the second adhesive layer.

13. The method of claim 7, further comprising the step of embossing the first and second layers of flocking.

14. The method of claim 13, wherein the embossing applied to the first layer of flocking has a different pattern than the embossing applied to the second layer of flocking.

15. The method of claim 7, wherein the lengths of the fibers forming the first layer or flocking are different from the lengths of the fibers forming the second layer of flocking.

16. A flocked fabric comprising:
a fabric substrate coated with a first adhesive layer to which glitter particulates have been adhered in a first group of regions and to which flocking has been adhered in a second group of regions wherein the first group of regions is devoid of flocking and the second group of regions if devoid of glitter particulates.

17. The flocked fabric of claim 16, further comprising a second adhesive layer and a flocked layer between the fabric substrate and the first adhesive layer.

18. In a method of fabricating a flocked fabric having a quantity of glitter particulates dispersed therein, the step of depositing glitter particulates onto a wet adhesive layer prior to and separately from a subsequent step of applying flocking to said wet adhesive layer.

19. A flocked fabric comprising:
a fabric substrate coated with a first adhesive layer to which glitter particulates have been adhered and to which flocking has been adhered; wherein the glitter particulates are positioned on the surface of the first adhesive layer, and wherein the first adhesive layer except at the surface is substantially free of glitter particulates.
